(19) United States
(12) Patent Application Publication
(10) Pub. No.: US 2015/0193076 A1
(43) Pub. Date: Jul. 9, 2015

(54) Touch Sensing Method and Device

(71) Applicant: MELFAS INC., Seongnam-si, Gyeonggi-do (KR)

(72) Inventor: Minsang Kim, Anyang-si (KR)

(21) Appl. No.: 14/414,400

(22) PCT Filed: Jul. 19, 2013
(86) PCT No.: PCT/KR2013/006501

§ 371 Date: Jan. 12, 2015

(30) Foreign Application Priority Data
Jul. 19, 2012 (KR) 10-2012-0078711

(51) Int. Cl. G06F 3/041; G06F 3/0354

(52) U.S. Cl. CPC G06F 3/0418; G06F 3/03545

(57) ABSTRACT

The present invention relates to a touch sensing method including: determining whether a touch input is performed through a touch pen, if a touch sensing device has received the touch input; setting the input mode of the touch sensing device to a pen mode if it is determined that the touch input has been performed through the touch pen; setting a touch input threshold range according to the pen mode; and calculating input coordinates provided as a result of performing the touch input.

### TECHNICAL FIELD

Embodiments of the inventive concept relate touch sensing device and method capable of processing an input that is performed using a touch pen.

### BACKGROUND ART

A touch screen recognizes user's screen touch or gesture as input information and is classified as a resistive type, a capacitance type, an ultrasonic wave type, or an infrared type according to an operating manner. Among such types, the capacitance type is a type in which when the touch screen is touched by a conductive object, a position of the object is sensed using a capacitance variation between the object and a transparent sensing electrode. A capacitance type touch screen has the following good characteristics as compared with other types of touch screens: long life, thin thickness, and fast response. For this reason, the capacitance type touch screen is used in various fields.

As a screen of an electronic device becomes larger and the size of the electronic device is scaled down, recently, a touch screen coupled with a display is used as a unique input means without an input device such as a keypad.

In the capacitance type touch screen, a user performs a touch input using fingers. On this occasion, since a contact area is relatively wide and a screen of an input portion is covered with fingers, it is difficult to allow a user to input at a desired point minutely. Thus, there is a problem to draw pictures or write letters.

In recent years, a touch pen-based input manner has been applied to the capacitance type touch screen. However, upon performing a touch input using a pen, in general, a contact area with a touch screen is narrower than the user's finger. For this reason, capacitance induced on a touch sensor is small, thereby making it difficult to recognize a touch. For this reason, an input processing manner that differs from a manner for processing a finger-based touch input is required to recognize a touch input using a touch pen exactly.

### DISCLOSURE

### Technical Problem

Embodiments of the inventive concept provide touch sensing method and device capable of exactly detecting a touch input that is performed using a touch pen.

### Technical Solution

One aspect of embodiments of the inventive concept is directed to provide a touch sensing method which includes determining whether a touch input is an input through a touch pen, when the touch input is generated on a touch sensing device; setting an input mode of the touch sensing device to a pen mode as a consequence of determining that the touch input is an input through the touch pen; setting a touch input threshold range according to the pen mode; and calculating input coordinates according to the touch input.

The determining may include determining whether a maximum sensitivity value of a touch input region is included in a predetermined touch pen determination range.

The determining may include comparing a maximum sensitivity value of the touch input with a width of a touch input region.

The determining may include checking a touch input sensitivity of a peripheral region of a touch input region having a maximum sensitivity value.

The touch input threshold range according to the pen mode may be set to be smaller than a contact area when the touch pen is in contact with the touch sensing device.

The setting of a touch input threshold range may include setting the touch input threshold range according to the pen mode; and setting a reference adjustment value for a reference tracking operation of the touch sensing device.

The determining of whether to release the pen mode may include determining whether a touch input release state is maintained over a predetermined time after the touch input is released.

The determining of whether to release the pen mode may include determining whether a maximum sensitivity value of a touch input region is included in a predetermined touch pen determination range; comparing a maximum sensitivity value of the touch input with a width of the touch input region; and checking a touch input sensitivity of a peripheral region of the touch input region having the maximum sensitivity value.

The touch pen may include a contact portion for a contact with the touch sensing device and a body portion, the contact portion including a conductive material and the body portion including a metal material.

Another aspect of embodiments of the inventive concept is directed to provide a touch sensing device which includes a touch panel and a touch sensing control unit. Thea touch panel receives a touch signal of a user. Thea touch sensing control unit performs operations of determining whether a touch input is an input through a touch pen, when the touch input is generated on a touch sensing device; setting an input mode of the touch sensing device to a pen mode as a consequence of determining that the touch input is an input through the touch pen; setting a touch input threshold range according to the pen mode; and calculating input coordinates according to the touch input.

### Advantageous Effects

When a touch input is generated, a capacitance type touch sensing device according to an exemplary embodiment of the inventive concept may determine whether the touch input is an input through a pen and may switch an input mode into a pen input mode as a consequence of determining that the touch input is an input through a pen, thereby performing an input processing operation optimized for a pen input and making it possible to detect a touch input using a finger and a touch input using a pen exactly. Also, the capacitance type touch sensing device according to an exemplary embodiment of the inventive concept may exactly detect a touch input through a touch pen that has a stylus tip of which the diameter is below 4 mm.

### DESCRIPTION OF DRAWINGS

FIG. 1 is a diagram showing an example where a touch input is performed using a touch pen in a conventional capacitance type touch sensing device;

FIG. 2 is a diagram showing a configuration of a capacitance type touch sensing device according to an exemplary embodiment of the inventive concept;

FIG. 3 is a flow chart showing a capacitance type touch sensing method according to an exemplary embodiment of the inventive concept;

FIG. 4 is a diagram showing an example of a touch sensitivity of each touch region at the time of touch input using a finger and an example of a touch sensitivity of each touch region at the time of touch input using a touch pen; and

FIG. 5 shows diagrams indicating an example of an input region on a touch panel formed at the time of touch input using a touch pen and indicating an example of an input region on a touch panel formed at the time of touch input using a finger.

### BEST MODE

Hereinafter, exemplary embodiments of the present invention will be described. In the drawings, the thickness and spacing are schematically illustrated for convenience in description and may be exaggerated in comparison to an actual thickness. In describing the present invention, a well-known configuration unrelated to the gist of the present invention may be omitted.

In the specification, in adding reference numerals to elements throughout the drawings, it is to be noted that like reference numerals refer to like elements even though elements are shown in different drawings.

Touch sensing method and device according to an exemplary embodiment of the inventive concept will be more fully described with reference to accompanying drawings.

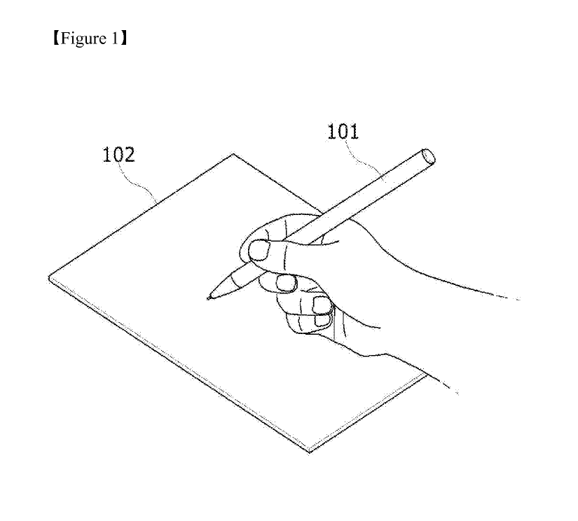

FIG. 1 is a diagram showing an example where a touch input is performed using a touch pen in a conventional capacitance type touch sensing device.

Referring to FIG. 1, when a touch input is performed using a touch pen 101 in a conventional capacitance type touch sensing device, a user may grab the touch pen 101 and may make the touch pen 101 contact a touch panel 102 for handwriting. At this time, a contact with a user's body, for example, a hand grabbing the touch pen 101 or a hand supporting the touch panel 102 may not be recognized as a touch input.

Meanwhile, a user tilts the touch pen 101 upon writing. For this reason, in many cases, an area actually touched on the touch panel 102 may be below 2-pi when a tip of the touch pen 101 is below 4-pi (diameter 4 mm). Thus, a threshold value of a touch input range may be set to be below 2-pi for recognition of an input through the touch pen 101. However, in the event that the threshold value of the touch input range is set to be below 2-pi, generation of a touch input may be recognized even when hovering occurs at a point adjacent to the touch panel 102 without an actual touch. Touch recognition performance may be deteriorated due to an increase in influence of noise that is generated according to other environmental factors.

To solve the above-described problem, the inventive concept may define the event that a touch input using the user's body is generated, as a normal mode in which the threshold value of the touch input range is set to 4-pi and may define the event that an input using a touch pen is generated, as a pen mode. The threshold value of the touch input range may be set to 1.5-pi only upon entering the pen mode.

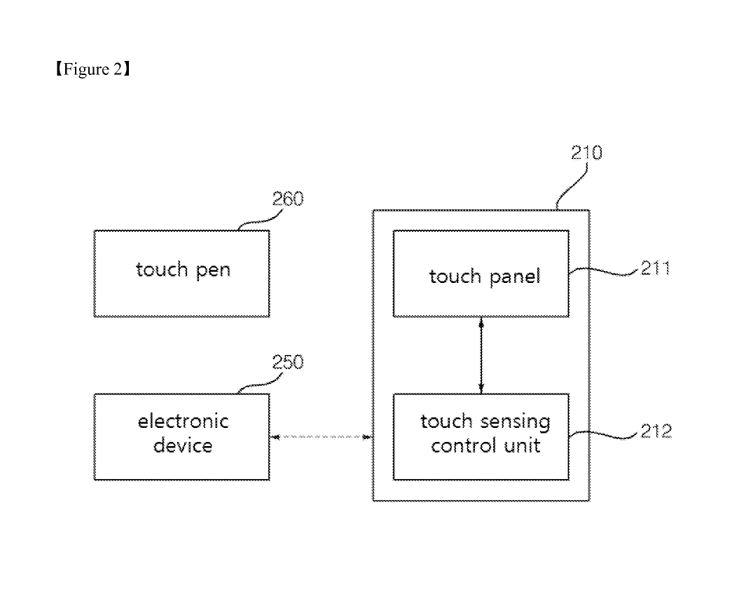

FIG. 2 is a diagram showing a configuration of a capacitance type touch sensing device according to an exemplary embodiment of the inventive concept. Referring to FIG. 2, a capacitance type touch sensing device 210 according to an exemplary embodiment of the inventive concept may contain a touch panel 211 and a touch sensing control unit 212.

In general, the touch sensing device 210 may be coupled with an electronic device 250. The electronic device 250 may be disposed around the touch panel 211 and may mean a device that is driven by a clock signal or a driving signal to generate an electromagnetic wave. For example, since the touch panel 211 is generally disposed on a display panel for displaying images, the electronic device 250 may be a display panel, a voltage supply unit for supplying a voltage to the touch panel 211, or an electronic device that is disposed outside the touch sensing device 210 including the touch panel 211 and generates an electromagnetic wave.

The electronic device 250 may be a display panel. As a panel for displaying images, the display panel may be liquid crystal display panel, electrophoretic display panel, OLED (Organic Light Emitting Diode) panel, LED panel, inorganic EL (Electro Luminescent Display) panel, FED (Field Emission Display) panel, SED (Surface-conduction Electronemitter Display) panel, PDP (Plasma Display Panel), or CRT (Cathode Ray Tube) display panel. The touch panel 211 may be stacked on one surface of the display panel. For the sake of easy understanding, an embodiment of the inventive concept is exemplified as the electronic device 250 is a display panel. However, the scope and spirit of the inventive concept may not be limited thereto. It is obvious that there are used all electronic devices that generate an electromagnetic wave outside the touch panel 211 and affect an operation of the touch panel 211.

The display panel may be a liquid crystal display panel that is driven using a clock signal. An embodiment of the inventive concept is exemplified as the electronic device 250 is a liquid crystal display panel among display panels. However, the scope and spirit of the inventive concept may not be limited thereto. It is obvious that there are used various sorts of display panels driven by a clock signal or a driving signal.

The touch panel 211 may be disposed to be adjacent to the electronic device 250 and may receive user's touch signals. The touch panel 211 may be disposed on a display panel for displaying images and may receive user's touch signals. The touch panel 211 may be a panel that receives user's touch signals and may be implemented in various shapes without limitation to a specific shape. For example, the touch panel 211 may be formed to have a two-layer structure. On this occasion, a touch sensor may be implemented with an array of pixels that are respectively formed at intersections of a plurality of driving electrode traces (e.g., traces extending in a Y-axis direction) and a plurality of sense electrode traces (e.g., traces extending in an X-axis direction). Alternatively, the touch panel 211 may be implemented with a touch panel 211 that has single-layered touch sensors disposed on the same plane and fabricated on one surface of a single substrate.

The touch sensing control unit 212 may apply a driving signal to the touch panel 211 and may receive a sensing signal from the touch panel 211. That is, the touch sensing control unit 212 may apply driving signals to the driving electrode traces of the touch panel 211 and may receive sensing signals from the sense electrode traces of the touch panel 211. The touch sensing control unit 212 may determine a touch position of a user, based on the driving signals applied to the touch panel 211 and the sensing signals received from the touch panel 211.

The touch sensing control unit 212 may be mounted on the touch panel 211 and may be disposed on the same plane as the driving electrode traces and the sense electrode traces of the touch panel 211. In some embodiments, the touch sensing control unit 212 may be mounted on not the touch panel 211 but a separate circuit board, and the circuit board on which the touch sensing control unit 212 is mounted may be electrically connected with the touch panel 211.

Also, when a touch input is performed on the touch panel 211, the touch sensing control unit 212 according to an exemplary embodiment of the inventive concept may determine whether the touch input is an input performed using a touch pen. As a consequence of determining that the touch input is an input performed using the touch pen (in other words, an input through the touch pen), the touch sensing control unit 212 may set an input mode of the touch sensing device 210 to a pen mode, may set a touch input threshold range corresponding to the pen mode, and may calculate the input coordinates of the touch input.

To determine whether a touch input is an input through a touch pen, the touch sensing control unit 212 may determine whether a maximum sensitivity value is included in a predetermined touch pen determination range, may compare the maximum sensitivity value of the touch input with a width of the touch input region, and may check a touch input sensitivity of a peripheral region of the touch input region having the maximum sensitivity value.

The touch sensing control unit 212 may set the touch input threshold range corresponding to the pen mode so as to be smaller than a contact area when the touch pen is in contact with the touch sensing device 210.

Also, the touch sensing control unit 212 may set the touch input threshold range corresponding to the pen mode and may set a reference adjustment value for a reference tracking operation of the touch sensing device 210.

Also, the touch sensing control unit 212 may determine whether to release the pen mode. Whether to release the pen mode may be determined according to whether a touch input release state remains over a predetermined time after a touch input is released. Upon entering the pen mode, the pen mode may be maintained during a predetermined time and may be released after the predetermined time elapses.

Also, the pen mode may be released by determining whether an input is performed through a pen, based on a reference that corresponds to a reference for determining whether or not of a pen input. For example, the touch sensing control unit 212 may set to release the pen mode when a maximum sensitivity value of a touch input region is not included in a touch pen determination range, the maximum sensitivity value of the touch input region is smaller than a width of the touch input region, and a touch input sensitivity with similar magnitude exists at eight directions on the basis of the touch input region having a maximum input sensitivity.

A touch pen 260 may be a conductive stylus pen causing electrostatic induction with the touch panel 211. In the conductive stylus pen, a contact portion (tip) contacting with the touch panel 211 may include a conductive silicon rubber or a conductive fiber containing carbon, and a body portion may include metal, thereby causing the electrostatic induction with the touch panel 211.

The touch pen 260 may be independent of the electronic device 250. For the user's convenience, the touch pen 260 may be inserted in the electronic device 250 so as to be carried together with the electronic device 250. Also, in some cases, the touch pen 260 may be electrically connected with the electronic device 250 or may communicate with the electronic device 250.

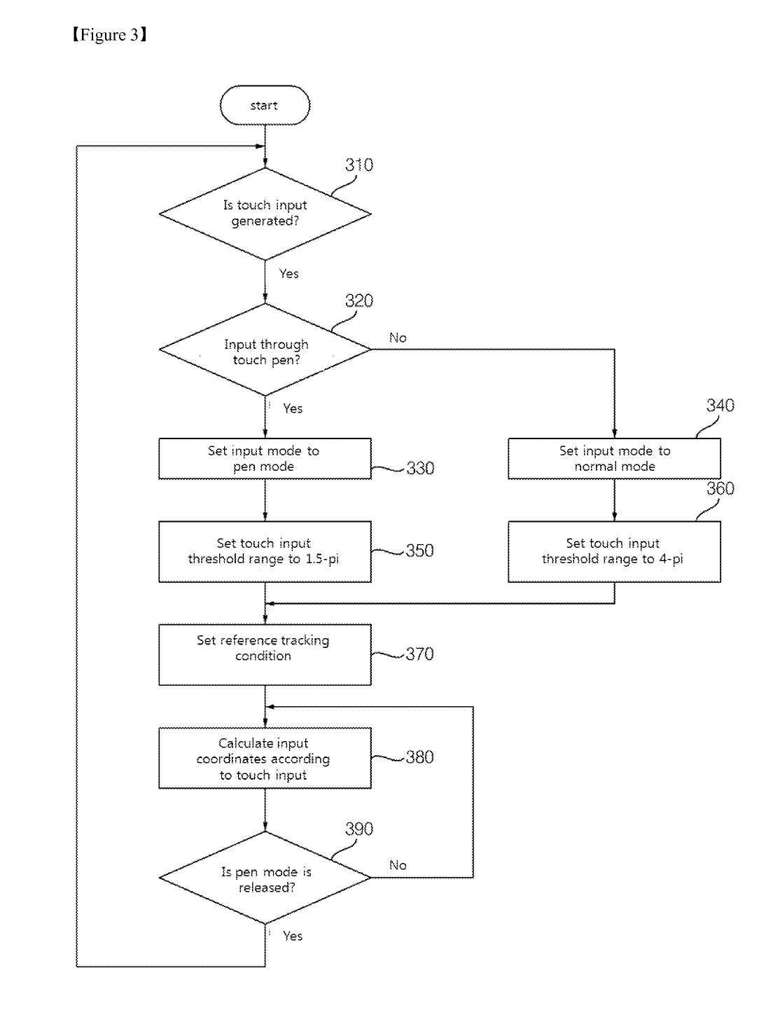

FIG. 3 is a flow chart showing a capacitance type touch sensing method according to an exemplary embodiment of the inventive concept.

Referring to FIG. 3, in step 310, a touch sensing control unit 212 may determine whether a touch input is generated on a touch panel 211. In step 320, the touch sensing control unit 212 may determine the generated touch input is an input through a touch pen (in other words, an input performed using a touch pen). In step 320, the touch sensing control unit 212 may determine a touch input region when the touch input is generated. The touch input region may be determined using watershed algorithm. Next, the touch sensing control unit 212 may determine whether a maximum sensitivity value of two initial frames of the touch input region at the time of touch input belongs to a predetermined touch pen determination range. The touch pen determination range may be set to about 20˜30 percentage of the maximum sensitivity value of the touch input region when the touch input using a finger is generated. For example, a predetermined touch pen determination range may be set to 10˜20 in the event that the maximum sensitivity value of the touch input region at the time of the touch input using a finger is 55˜60 on average.

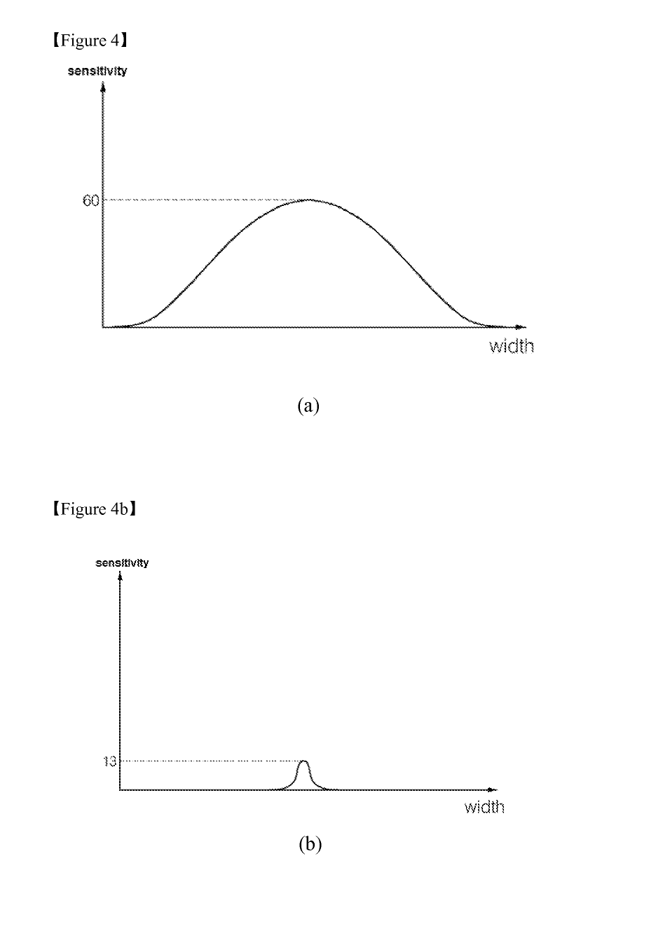

FIG. 4 is a diagram showing an example of a touch sensitivity of each touch region at the time of touch input using a finger and an example of a touch sensitivity of each touch region at the time of touch input using a touch pen. Since a relatively wide contact area occurs upon performing a touch input using a finger, a characteristic of an input region may be as illustrated in (a) of FIG. 4. In contrast, since a relatively narrow contact area occurs upon performing a touch input using a touch pen, a characteristic of an input region may be as illustrated in (b) of FIG. 4.

Referring to FIG. 4, a maximum sensitivity of a touch input region using a finger may be 60 as illustrated in (a) of FIG. 4, and a maximum sensitivity of a touch input region using a touch pen may be 13 as illustrated in (b) of FIG. 4. Also, a maximum sensitivity of a touch input region using a finger may be smaller than a width of the touch input region using a finger, and a maximum sensitivity of a touch input region using a touch pen may be greater than a width of the touch input region using a touch pen.

To detect an input through a touch pen based on the above feature, the inventive concept may determine whether a maximum sensitivity value of a touch input region is included in a touch pen determination range and may determine whether the maximum sensitivity value of the touch input region is greater than a width of the touch input region.

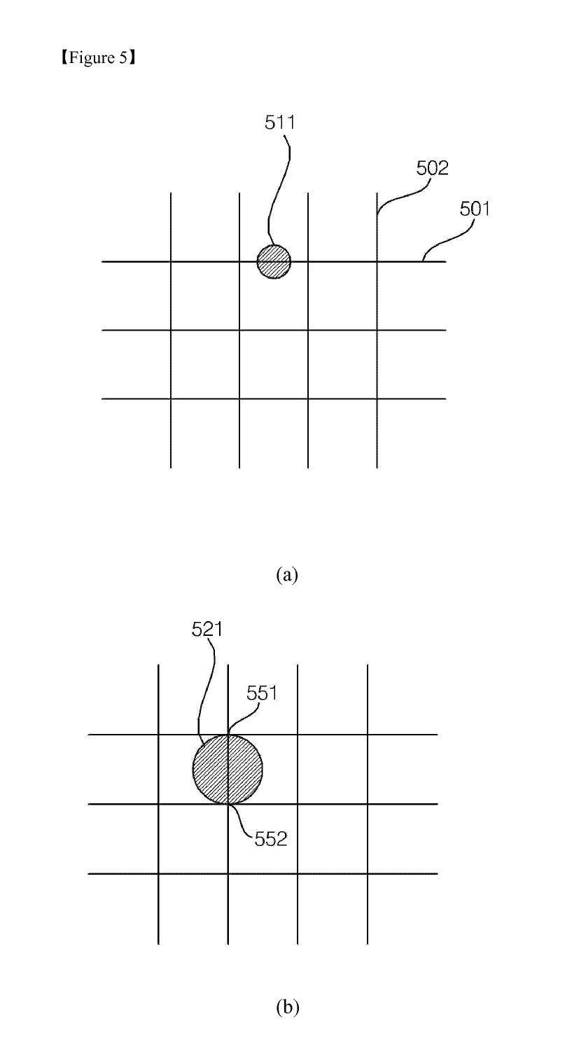

FIG. 5 shows diagrams indicating an example of an input region on a touch panel formed at the time of touch input using a touch pen and indicating an example of an input region on a touch panel formed at the time of touch input using a finger. In exemplary embodiments, a touch panel may include arrangement of a plurality of sensing electrode traces 501 and a plurality of driving electrode traces 502. In this case, an interval between adjacent electrode traces may be set to 4 mm. In exemplary embodiments, an intersection of a sensing electrode trace 501 and a driving electrode trace 502 of the touch panel may be set to a capacitance sensing region.

In FIG. 5, (a) shows an example of a touch input region when an input through a touch pen is generated on a touch panel of the inventive concept. In case of an input through a touch pen, in general, a contact region may be below 2-pi. For this reason, as illustrated in (a) of FIG. 5, an input region 511 through a pen may be mainly detected only at a sensing electrode trace; in contrast, touch inputs with similar magnitude may not be detected at a plurality of sensing electrode traces.

In FIG. 5, (b) shows an example of a touch input region when an input through a finger is generated on a touch panel of the inventive concept. In case of an input through a finger, in general, a contact region with the touch panel may be over 4-pi. For this reason, as illustrated in (b) of FIG. 5, an input region 521 through a finger may be formed over a plurality of sensing electrode traces; hence, a touch input with similar sensitivity may be detected at capacitance sensing regions 551 and 552 of adjacent sensing electrode traces.

As described above, when an input through a finger is generated, a touch input of similar magnitude may be detected at an adjacent capacitance sensing region. However, since a contact area is narrow at the time of input through a touch pen, a touch input with similar magnitude may not be detected at a peripheral capacitance sensing region. Thus, when an input is generated on a touch panel, the inventive concept may determine whether a touch input of similar magnitude is generated at a peripheral capacitance sensing region of a capacitance sensing region having a maximum sensitivity. For example, peripheral capacitance sensing regions of eight directions (up, down, left, right, up and left, down and left, up and right, and down and right) on the basis of a capacitance sensing area having a maximum touch input sensitivity may be checked to determine whether there exists a capacitance sensing area having a touch input sensitivity similar to the maximum touch input sensitivity.

For example, in the event that a peripheral capacitance sensing region having a touch input sensitivity over 80% of a maximum touch input sensitivity exists, there may be determined that a capacitance sensing region having a touch input sensitivity of similar magnitude exists.

According to the above description, in step 320, the touch sensing control unit 212 may determine a corresponding touch input as a touch input through a touch pen, in the event that a maximum sensitivity value of a touch input region is included in a touch pen determination range, the maximum sensitivity value of the touch input region is greater than a width of the touch input region, and a touch input sensitivity of similar magnitude does not exist at eight directions on the basis of the touch input region having a maximum input sensitivity. Meanwhile, an embodiment of the inventive concept is exemplified as whether or not of a touch input through a touch pen is determined based on all three conditions above described. However, the scope and spirit of the inventive concept may not be limited thereto. For example, whether a touch input is performed using a touch pen may be determined based on one or two of the three conditions above described.

When a determination result of step 320 indicates that a touch input is an input through a touch pen, in step 330, an input mode of the touch sensing device 210 may be set to a pen mode. In step 350, the touch sensing device 210 may set a touch input threshold range to 1.5-pi. Afterwards, the method proceeds to step 370. Meanwhile, an embodiment of the inventive concept is exemplified in step 350 as the touch input threshold range is set to 1.5-pi. However, the touch input threshold range may be changed to have any value ranging from 1-pi to 2-pi.

When a determination result of step 320 indicates that a touch input is not an input through a touch pen, in step 340, an input mode of the touch sensing device 210 may be set to a normal mode. In step 360, the touch sensing device 210 may set the touch input threshold range to 4-pi. Afterwards, the method proceeds to step 370.

In step 370, the touch sensing control unit 212 may set a reference tracking condition of the touch sensing device 210. The reference tracking may mean a technique for minimizing a variation in a peripheral environment or influence of noise by adjusting an initial value of a reference current (or, voltage), changed by a variation in capacitance at the time of touch input, below a reference adjustment value within a stable margin in the light of a variation in a peripheral environment of a touch sensing device or noise. In exemplary embodiments, a reference adjustment value for the reference tracking may be set differently according to an input mode. Preferably, a reference adjustment value for a pen mode may be set to be smaller than that for a normal mode.

In step 380, the touch sensing control unit 212 may calculate the input coordinates according to the touch input and may send it to the electronic device 250.

In step 390, the touch sensing control unit 212 may determine whether to release a pen mode. As a consequence of determining that the pen mode is not released, the method proceeds to step 380 in which the input coordinates are calculated. As a consequence of determining that the pen mode is released, the method proceeds to step 310.

In step 390, the touch sensing control unit 212 may determine that the pen mode is released, in the event that a touch input is released. However, in case of the pen mode, a touch release may iteratively occur during a short time between inputs of strokes of a character upon inputting the character. If the pen mode is released between strokes of the character, then an operation for checking whether to enter the pen mode may be iteratively required whenever a new stroke is input. In exemplary embodiments, the pen mode may be released only if a touch input is released and a touch input release state is maintained over 1 second.

Meanwhile, upon entering the pen mode, the pen mode may be maintained during a predetermined time and may be released after the predetermined time elapses.

Also, the pen mode may be released by determining whether or not of an input through a pen based on a reference that corresponds to a reference for determining whether or not of a pen input determined in step 320. For example, the touch sensing control unit 212 may set to release the pen mode when a maximum sensitivity value of a touch input region is not included in a touch pen determination range, the maximum sensitivity value of the touch input region is smaller than a width of the touch input region, and a touch input sensitivity with similar magnitude exists at eight directions around a maximum input sensitivity of the touch input region.

With the above-described operation and configuration, when an input is generated or performed on a touch panel, the touch sensing method and device according to an exemplary embodiment of the inventive concept may exactly determine whether the touch input is an input through a touch pen and may optimize the touch sensing device by a touch pen input mode as a consequence of determining that the touch input is an input through a touch pen, thereby making it possible to recognize a touch pen input exactly.

Touch sensing method and device according to an exemplary embodiment of the inventive concept may be implemented as described above. While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

1. A touch sensing method comprising:
determining whether a touch input is an input through a touch pen, when the touch input is generated on a touch sensing device;
setting an input mode of the touch sensing device to a pen mode as a consequence of determining that the touch input is an input through the touch pen;
setting a touch input threshold range according to the pen mode; and
calculating input coordinates according to the touch input.

2. The touch sensing method of claim 1, wherein the determining includes:
determining whether a maximum sensitivity value of a touch input region is included in a predetermined touch pen determination range.

3. The touch sensing method of claim 1, wherein the determining includes:
comparing a maximum sensitivity value of the touch input with a width of a touch input region.

4. The touch sensing method of claim 1, wherein the determining includes:
checking a touch input sensitivity of a peripheral region of a touch input region having a maximum sensitivity value.

5. The touch sensing method of claim 1, wherein the touch input threshold range according to the pen mode is set to be smaller than a contact area when the touch pen is in contact with the touch sensing device.

6. The touch sensing method of claim 1, wherein the setting of a touch input threshold range includes:
setting the touch input threshold range according to the pen mode; and
setting a reference adjustment value for a reference tracking operation of the touch sensing device.

7. The touch sensing method of claim 1, further comprising:
determining whether to release the pen mode.

8. The touch sensing method of claim 1, wherein the determining of whether to release the pen mode includes:
determining whether a touch input release state is maintained over a predetermined time after the touch input is released.

9. The touch sensing method of claim 1, wherein the determining of whether to release the pen mode includes:
determining whether a maximum sensitivity value of a touch input region is included in a predetermined touch pen determination range;
comparing a maximum sensitivity value of the touch input with a width of the touch input region; and
checking a touch input sensitivity of a peripheral region of the touch input region having the maximum sensitivity value.

10. The touch sensing method of claim 1, wherein the touch pen includes a contact portion for a contact with the touch sensing device and a body portion, the contact portion including a conductive material and the body portion including a metal material.

11. A touch sensing device comprising:
a touch panel configured to receive a touch signal of a user; and
a touch sensing control unit configured to perform operations of:
determining whether a touch input is an input through a touch pen, when the touch input is generated on a touch sensing device;
setting an input mode of the touch sensing device to a pen mode as a consequence of determining that the touch input is an input through the touch pen;
setting a touch input threshold range according to the pen mode; and
calculating input coordinates according to the touch input.

12. The touch sensing device of claim 11, wherein the determining of whether a touch input is an input through a touch pen includes determining whether a maximum sensitivity value of a touch input region is included in a predetermined touch pen determination range.

13. The touch sensing device of claim 11, wherein the determining of whether a touch input is an input through a touch pen includes comparing a maximum sensitivity value of the touch input with a width of a touch input region.

14. The touch sensing device of claim 11, wherein the determining of whether a touch input is an input through a touch pen includes checking a touch input sensitivity of a peripheral region of a touch input region having a maximum sensitivity value.

15. The touch sensing device of claim 11, wherein the touch input threshold range according to the pen mode is set to be smaller than a contact area when the touch pen is in contact with the touch sensing device.

16. The touch sensing device of claim 11, wherein the touch sensing control unit setting a touch input threshold range according to the pen mode includes:
setting the touch input threshold range according to the pen mode; and
setting a reference adjustment value for a reference tracking operation of the touch sensing device.

17. The touch sensing device of claim 11, wherein the touch sensing control unit is further configured to determine whether to release the pen mode.

18. The touch sensing device of claim 11, wherein the touch sensing control unit determining whether to release the pen mode includes determining whether a touch input release state is maintained over a predetermined time after the touch input is released.

19. The touch sensing device of claim 11, wherein the touch sensing control unit determining whether to release the pen mode includes:
determining whether a maximum sensitivity value of a touch input region is included in a predetermined touch pen determination range;
comparing a maximum sensitivity value of the touch input with a width of the touch input region; and
checking a touch input sensitivity of a peripheral region of the touch input region having the maximum sensitivity value.

20. The touch sensing device of claim 11, wherein the touch pen includes a contact portion for a contact with the touch sensing device and a body portion, the contact portion including a conductive material and the body portion including a metal material.
